(19) United States
(12) Patent Application Publication
(10) Pub. No.: US 2023/0137031 A1
(43) Pub. Date: May 4, 2023

(54) IMAGE PROCESSING DEVICE, IMAGE PROCESSING METHOD, LEARNING DEVICE, GENERATION METHOD, AND PROGRAM

(71) Applicant: SONY GROUP CORPORATION, Tokyo (JP)

(72) Inventor: Tomonori TSUTSUMI, Tokyo (JP)

(73) Assignee: SONY GROUP CORPORATION, Tokyo (JP)

(21) Appl. No.: 17/918,767

(22) PCT Filed: May 6, 2021
(86) PCT No.: PCT/JP2021/017334

§ 371 Date: Oct. 13, 2022

(30) Foreign Application Priority Data
May 20, 2020 (JP) 2020-088307

(51) Int. Cl. G06T 7/40; G06V 10/54; G06V 20/70

(52) U.S. Cl. CPC G06T 7/40; G06V 10/54; G06V 20/70; G06V 2201/07; G06T 2207/20081

(57) ABSTRACT

The present technology relates to an image processing device, an image processing method, a learning device, a generation method, and a program for enabling generation of an image in which an appropriate texture is expressed in each region.

An image processing device according to the present technology generates a control signal indicating the texture of each region in an output image as an inference result on the basis of an input image to be processed, inputs the input image to an inference model, and infers the output image in which each region has a texture indicated by the control signal, the inference model being obtained by performing learning based on a trainee image and a training image, the trainee image being generated by performing predetermined image processing on the training image, the texture of each region being expressed by a texture label in the training image. The present technology can be applied to various kinds of devices that handle images, such as TV sets, cameras, and smartphones.

### TECHNICAL FIELD

The present technology particularly relates to an image processing device, an image processing method, a learning device, a generation method, and a program for enabling generation of an image in which an appropriate texture is expressed in each region.

### BACKGROUND ART

In image quality adjustment of a display device such as a TV set, reproduction of textures and improvement of textures are required in some cases. Image processing for reproducing and improving textures is normally realized not by controlling the textures, but by combining techniques such as a noise reduction (NR) process, a super-resolution process, and a contrast/color adjustment process, or adjusting the intensity of image processing to create an image.

It can be said that textures can be qualitatively felt by human beings. Since it is difficult to define physical parameters suitable for expressing textures, it is also difficult to control textures by conventional model-based processing.

### CITATION LIST

### Patent Document

Patent Document 1: Japanese Patent Application Laid-Open No. 2018-190371

### SUMMARY OF THE INVENTION

### Problems to be Solved by the Invention

Textures are expressed by various expressions such as fineness, granularity, shape properties, glossiness, transparency, shadowiness, skin fineness, and irregularities. Optimum textures vary depending on the characteristics of objects.

Even if an object captured in an image is detected by semantic segmentation or the like, and processing corresponding to the texture is performed, performing processing for expressing the same texture for all objects or the entire region of the object is not always sufficient. That is, a failure might occur, unless processing for expressing an appropriate texture is performed on each region of the object.

The present technology has been made in view of such circumstances, and is to enable generation of an image in which an appropriate texture is expressed in each region.

### Solutions to Problems

An image processing device according to one aspect of the present technology includes: a control signal generation unit that generates a control signal indicating the texture of each region in an output image as an inference result, on the basis of an input image to be processed; and an image generation unit that inputs the input image to an inference model, and infers the output image in which each region has a texture indicated by the control signal, the inference model being obtained by performing learning based on a trainee image and a training image, the trainee image being generated by performing predetermined image processing on the training image, the texture of each region being expressed by a texture label in the training image.

A learning device according to another aspect of the present technology includes: an acquisition unit that acquires a texture label indicating the texture of each region of an image for learning; and a learning unit that generates an inference model by performing learning in accordance with a control signal indicating the texture of each region of the image for learning, using a trainee image and a training image, the trainee image being generated by performing predetermined image processing on the image for learning, the training image being the image for learning.

In one aspect of the present technology, a control signal indicating the texture of each region in an output image as an inference result is generated on the basis of an input image to be processed; and the input image is input to an inference model, and the output image in which each region has a texture indicated by the control signal is inferred, the inference model being obtained by performing learning based on a trainee image and a training image, the trainee image being generated by performing predetermined image processing on the training image, the texture of each region being expressed by a texture label in the training image.

In another aspect of the present technology, a texture label indicating the texture of each region of an image for learning is acquired, and an inference model is generated by performing learning in accordance with a control signal indicating the texture of each region of the image for learning, using a trainee image and a training image, the trainee image being generated by performing predetermined image processing on the image for learning, the training image being the image for learning.

### BRIEF DESCRIPTION OF DRAWINGS

FIG. 1 is a diagram illustrating an example of labels that are used in an image processing system according to the present technology.

FIG. 2 is a diagram showing examples of image processing for controlling textures.

FIG. 3 is a table showing examples of processes depending on objects.

FIG. 4 is a diagram showing an example configuration of an image processing system according to an embodiment of the present technology.

FIG. 5 is a block diagram showing an example configuration of a learning device.

FIG. 6 is a diagram showing examples of texture label settings.

FIG. 7 is a diagram showing an example of learning of a texture segmentation detection DNN.

FIG. 8 is a diagram showing an example of learning of a super-resolution processing DNN.

FIG. 9 is graphs showing examples of conversion of texture axis values.

FIG. 10 is a block diagram showing an example configuration of an image processing device.

FIG. 11 is a diagram showing an example of inference using a texture segmentation detection DNN.

FIG. 12 is a diagram showing an example of conversion of texture axis values.

FIG. 13 is a diagram showing an example of calculation of texture axis values.

FIG. 14 is a diagram showing an example of adjustment of texture axis values.

FIG. 15 is a diagram showing an example of inference using a super-resolution processing DNN.

FIG. 16 is a flowchart for explaining a texture label setting process to be performed by the learning device.

FIG. 17 is a flowchart for explaining a texture segmentation detection DNN generation process to be performed by the learning device.

FIG. 18 is a flowchart for explaining a super-resolution processing DNN generation process to be performed by the learning device.

FIG. 19 is a flowchart for explaining an inference process to be performed by the image processing device.

FIG. 20 is a diagram showing an example of settings of object labels and texture labels.

FIG. 21 is a diagram showing an example of settings of object labels and texture labels.

FIG. 22 is a diagram showing an example of settings of an object label and texture labels.

FIG. 23 is a diagram showing an example of inference using a super-resolution processing DNN.

FIG. 24 is a diagram showing an example of image quality labels.

FIG. 25 is a diagram showing an example of texture labels to which the intent of image creation is added.

FIG. 26 is a diagram schematically showing the image quality of an inference result.

FIG. 27 is a block diagram showing an example configuration of a computer.

### MODE FOR CARRYING OUT THE INVENTION

The following is a description of modes for carrying out the present technology. Explanation will be made in the following order.

1. Premise of the present technology

2. Example configuration of an image processing system

3. Learning of DNNs

4. Inference using DNNs

5. Operation of the image processing system

6. Examples of label setting

7. Example Applications

8. Other Examples

### Premise of the Present Technology

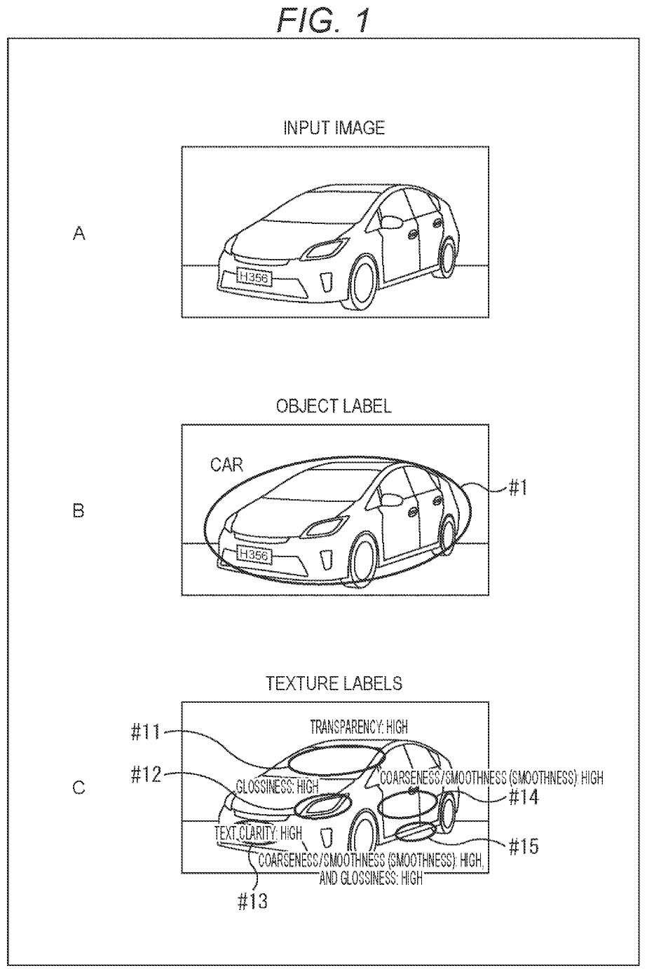

FIG. 1 is a diagram illustrating an example of labels that are used in an image processing system according to the present technology.

When an input image shown in A of FIG. 1 in which a car is captured is the image to be processed, an object label shown in B of FIG. 1 is used in image processing. The object label shown in B of FIG. 1 is information indicating that a car is shown in a region #1 that is a substantially central region of the input image.

In the example shown in B of FIG. 1, the region #1 is schematically illustrated as an elliptical region, but in practice, a region corresponding to the shape of the car is indicated by the object label. In the other drawings that will be described later, the shape of each region is also a shape corresponding to the shape of an object or the like captured in each region.

In the present technology, not only the object label but also texture labels shown in C of FIG. 1 are used.

The texture labels are information indicating the textures of the respective regions. As will be described later, a texture label evaluated by a person as suitable to express the texture is set in each region, in accordance with the content of an object or the like captured in each region.

In the example shown in C of FIG. 1, texture labels indicate that the texture of a region #11 in which the windshield is captured is “transparency: high”, and the texture of a region #12 in which a headlight is captured is “glossiness: high”.

Also, texture labels indicate that the texture of a region #13 in which the number plate is captured is “character clarity: high”, and the texture of a region #14 in which a side door is captured is “coarseness/smoothness (smoothness): high”. A texture labels indicates that the texture of a region #15 which is part of the floor surface is “coarseness/smoothness (smoothness): high” and “glossiness: high”.

As described above, the texture labels are information indicating the types of texture expressions expressing the qualitative textures of the respective regions, and the intensities of the textures expressed by the texture expressions. Each “: (colon)” is preceded by a type of texture expression, and is followed by the intensity of the texture.

The defined texture expressions include fineness, granularity, shape properties, glossiness, transparency, shadowiness, skin fineness, matteness, irregularities, a sizzling feeling, and the like. As for the intensity of each texture, the four levels of intensity, which are low, medium, high, and OFF (unlabeled), are defined, for example. Two levels of intensity, three levels of intensity, or five or more levels of intensity may be defined.

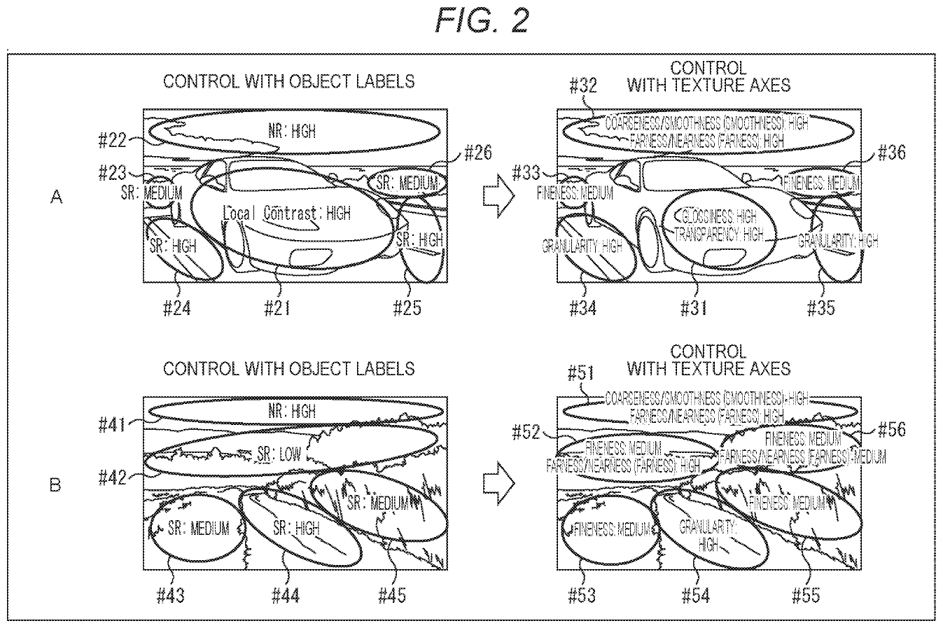

FIG. 2 is a diagram showing examples of image processing for controlling textures.

In FIG. 2, the left side shows image processing using object labels, and the right side shows image processing using texture labels.

When image processing for controlling textures such as reproducing and improving textures is performed with object labels, image processing is performed so that a contrast process is performed more strongly on a region #21 in which a car is captured, and a NR process is performed more strongly on a region #22 in which the sky is captured, as illustrated on the left side of A of FIG. 2, for example. Likewise, a super-resolution process (SR) of the intensity corresponding to the object is performed on the other regions.

As described above, the image processing for controlling textures using object labels is performed by combining a super-resolution process, a contrast/color adjustment process, an enhancement process, a NR process, and the like, for the region of each object.

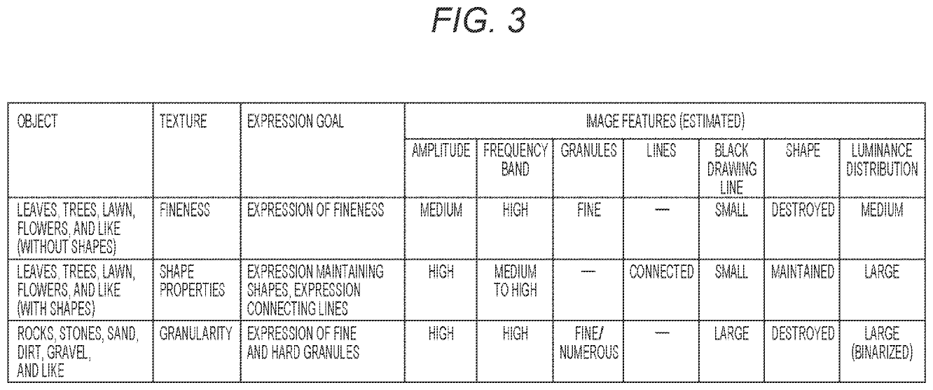

FIG. 3 is a table showing examples of processes depending on objects.

As shown in FIG. 3, when the object is “leaves, trees, a lawn, flowers, or the like (without shapes)”, processing or the like for setting the amplitude of an image signal to a medium range and the frequency band to a high range is performed so as to express fineness as a texture. As for the other objects, the types, the degrees, and the like of processing for expressing textures are also set in advance, and processing is performed.

It is not realistic to perform image processing on each region by combining various kinds of processing in accordance with the preset content, in terms of performance, processing amount, scale, time and effort for adjustment, and the like. Further, even if image processing is performed as set in advance, it is not clear whether desired textures will be obtained.

On the other hand, when texture control is performed using texture labels, image processing corresponding to “glossiness: high” and “transparency: high” is performed on a region #31 in which the body of the car is captured, and image processing corresponding to “coarseness/smoothness (smoothness): high” and “farness/nearness: high” is performed on a region #32 in which the sky is captured, as shown on the right side of A of FIG. 2, for example. Likewise, image processing corresponding to the respective textures is performed on the other regions, on the basis of the texture labels.

Image processing corresponding to a texture means image processing for obtaining the texture. For example, the image processing for the region #31 is image processing for obtaining a texture with a high glossiness and a high transparency.

As will be described later, in the image processing system of the present technology, image processing is performed using a deep neural network (DNN), to generate images. The fact that image processing corresponding to textures is performed on the respective regions means that an image including the respective regions in which the textures are obtained is generated.

As described above, texture labels are introduced into the image processing system of the present technology. By introducing texture labels so that textures can be directly controlled, it is possible to perform image quality control in accordance with a qualitative sense of a person. That is, image creation and image quality adjustment based on human senses can be performed.

Even in regions in which the same object is captured, the optimum texture differs for each region depending on, for example, the characteristics of the materials of the respective portions constituting the object. By introducing texture labels, it is possible to control the texture of each region in accordance with the characteristics of part of the object or an image creation policy. Further, by becoming capable of controlling intensities of textures, it is possible to increase image quality adjustment controllability.

As described above, in the image processing according to the present technology, texture axes, which are new control axes different from the control axis of the conventional image quality control, are provided. By changing texture labels, it is also possible to provide a control axis specialized in a use case at an image output destination.

### Example Configuration of an Image Processing System

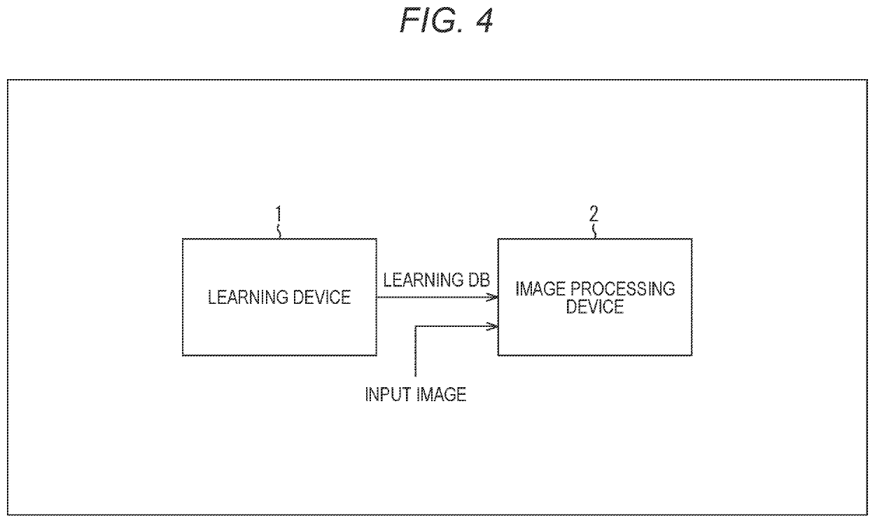

FIG. 4 is a diagram showing an example configuration of an image processing system according to an embodiment of the present technology.

The image processing system in FIG. 4 includes a learning device 1 and an image processing device 2. The learning device 1 and the image processing device 2 may be formed with devices in the same housing, or may be formed with devices in different housings.

The learning device 1 creates learning data of an inference model such as a DNN. The learning device 1 performs learning using the learning data, to generate a DNN.

As will be described later in detail, a DNN for associating texture labels with the region to be subjected to texture control is generated through the learning performed by the learning device 1. When an image to be processed is input to this DNN, a texture label of each region is output. The DNN that associates the texture labels with the regions to be subjected to texture control is a texture segmentation detection DNN to be used for detecting the regions to be subjected to texture control with the texture labels.

Also, through the learning performed by the learning device 1, a super-resolution processing DNN that is a DNN capable of controlling the super-resolution process using texture axis values as a control signal is generated. The texture axis value is a value determined on the basis of a texture label as described later. When an image to be processed is input to the super-resolution processing DNN, a high-resolution image (a super-resolution image) subjected to a super-resolution process corresponding to the texture axis value is output.

The learning device 1 outputs information about the two DNNs, which are the texture segmentation detection DNN and the super-resolution processing DNN, as a learning database (DB) to the image processing device 2, the information including information about the coefficients constituting the respective layers.

The image processing device 2 generates a high-resolution image based on an input image by performing inference using the texture segmentation detection DNN and the super-resolution processing DNN. For example, an image of each of the frames constituting a moving image captured by a camera is supplied as an input image to the image processing device 2. A computer graphics (CG) moving image may be supplied as an input image, or a still image may be supplied as an input image.

### Learning of DNNs

### Configuration of the Learning Device 1

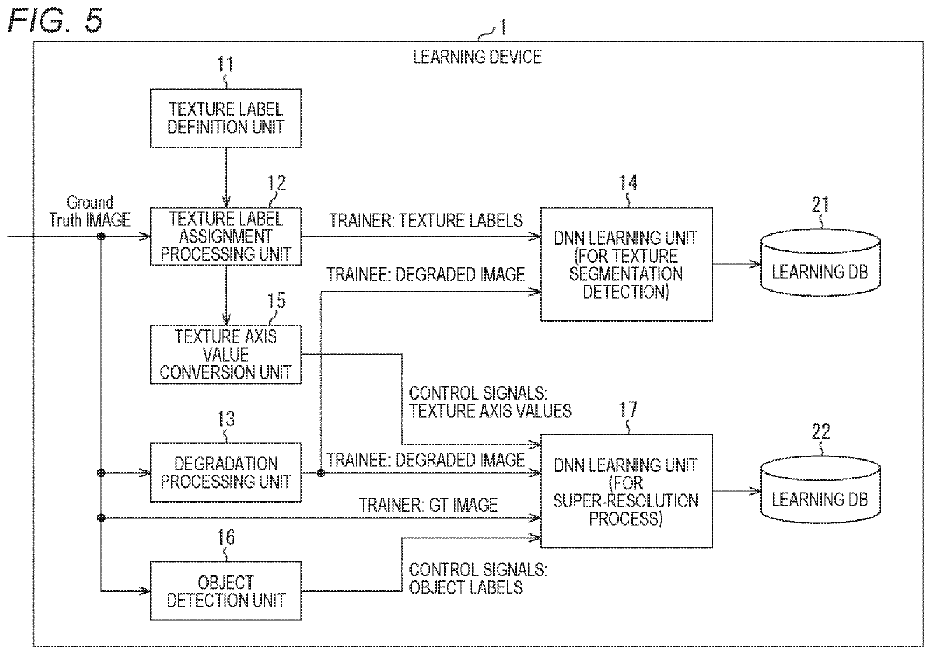

FIG. 5 is a block diagram showing an example configuration of the learning device 1.

The learning device 1 includes a texture label definition unit 11, a texture label assignment processing unit 12, a degradation processing unit 13, a DNN learning unit 14, a texture axis value conversion unit 15, an object detection unit 16, and a DNN learning unit 17. A ground truth image that is an image for learning is input to the texture label assignment processing unit 12, the degradation processing unit 13, the object detection unit 16, and the DNN learning unit 17. When the image processing to be performed in the image processing device 2 is a super-resolution process, the ground truth image is a high-resolution image.

The texture label definition unit 11 outputs information that defines the types, the intensities, and the like of texture labels, to the texture label assignment processing unit 12.

The texture label assignment processing unit 12 sets a texture label in each region of the ground truth image (GT image), in accordance with the user's operation. At the time of setting texture labels, the user who looks at the GT image performs an operation to designate a texture label for each region. The texture label assignment processing unit 12 outputs information about the texture label of each region to the DNN learning unit 14 and the texture axis value conversion unit 15. The texture label assignment processing unit 12 functions as an acquisition unit that acquires the texture labels indicating the textures of the respective regions of the GT image.

The degradation processing unit 13 performs a degradation process on the GT image, to generate a degraded image. The degradation processing unit 13 outputs the degraded image to the DNN learning unit 14 and the DNN learning unit 17. The degradation process performed by the degradation processing unit 13 is a down-conversion process for generating an image corresponding to a low-resolution image to be an input in a super-resolution process.

The DNN learning unit 14 performs learning, with the training data being the texture labels supplied from the texture label assignment processing unit 12, and the trainee data being the degraded image supplied from the degradation processing unit 13. Thus, a texture segmentation detection DNN is generated. The DNN learning unit 14 outputs information such as the coefficients of the respective layers constituting the texture segmentation detection DNN, as a learning DB 21.

The texture axis value conversion unit 15 converts the intensities of the textures of the respective regions into texture axis values, on the basis of the texture labels supplied from the texture label assignment processing unit 12. The texture axis value conversion unit 15 outputs information about the texture axis values of the respective regions to the DNN learning unit 17.

The object detection unit 16 performs processing such as semantic segmentation on the GT image, to detect the objects captured in the respective regions (the objects included in the respective regions) of the GT image. The objects may be detected through a process different from semantic segmentation. The object detection unit 16 outputs object labels indicating the objects captured in the respective regions, to the DNN learning unit 17.

The DNN learning unit 17 performs learning, with the training image being the GT image, and the trainee image being the degraded image supplied from the degradation processing unit 13. Thus, a super-resolution processing DNN is generated. A DNN having a predetermined network structure, such as a generative adversarial network (GAN), is generated as the super-resolution processing DNN. A DNN process using a GAN, and a DNN process such as a style transfer have a high ability to bring the input image closer to the taste of the correct training image group, and thus, the textures can be expressed.

The learning by the DNN learning unit 17 is performed, with control signals being the texture axis values supplied from the texture axis value conversion unit 15 and the object labels supplied from the object detection unit 16. Coefficients for generating images with different textures as images of the respective regions are learned for each combination of the texture axis values of the respective regions and the objects captured in the respective regions. The DNN learning unit 17 outputs information such as the coefficients of the respective layers constituting the super-resolution processing DNN, as a learning DB 22.

The processes to be performed by the respective components of the learning device 1 are described below in detail.

### Texture Label Settings

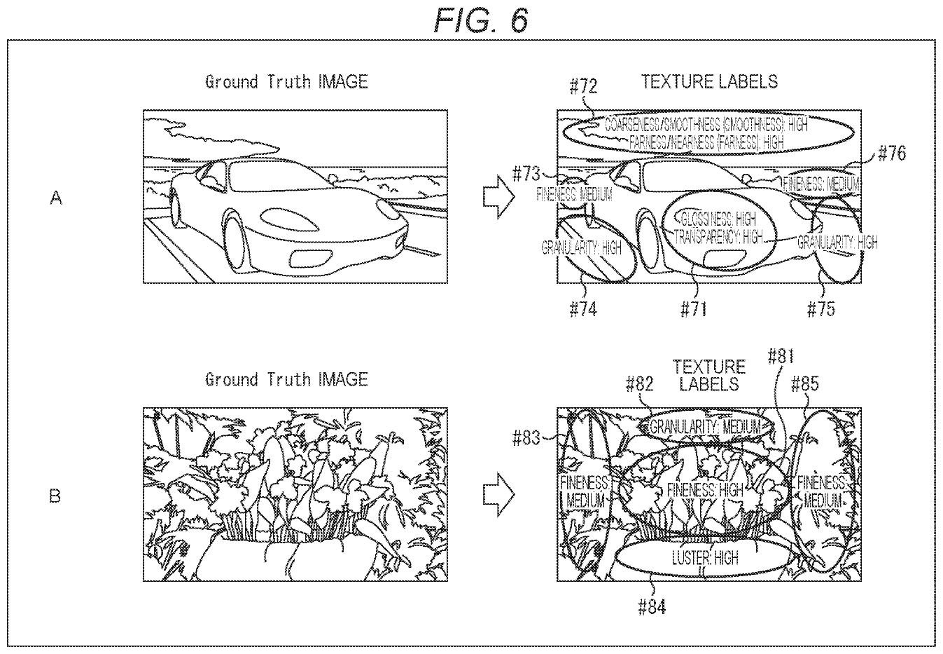

FIG. 6 is a diagram showing examples of texture label settings.

Texture labels are information indicating the types of texture expressions expressing the textures of the respective regions, and the intensities of the textures expressed by the texture expressions.

A texture label is set in each region of a GT image by the user who has viewed the GT image and evaluated the texture of each region. The user evaluates the texture of each region of the GT image, in accordance with the characteristics of the respective portions constituting objects and the image creation policy. In response to the user's operation, the texture label assignment processing unit 12 sets a texture label in each region of the GT image.

In an example shown in A of FIG. 6, in a GT image, a texture label “glossiness: high” and a texture label “transparency: high” are set in a substantially central region #71 in which the body of a car is captured, and a texture label “coarseness/smoothness (smoothness): high” and a texture label “farness/nearness: high” are set in a region #72 in which the sky is captured.

A texture label “fineness: medium” is set in a region #73 and a region #76 in which a distant landscape is captured, and a texture label “granularity: high” is set in a region #74 and a region #75 in which the road surface is captured.

In an example shown in B of FIG. 6, in a GT image, a texture label “fineness: high” is set in a substantially central region #81 in which flowers are captured, and a texture label “granularity: medium” is set in a region #82 in which the background is captured.

A texture label “fineness: medium” is set in a region #83 and a region #85 in which the background is captured, and a texture label “luster: high” is set in a region #84 in which a plant pot is captured.

Such texture labels are set for various GT images.

As the labeling for evaluating the textures of a ground truth image is manually performed, textures that are felt qualitatively by human beings are incorporated as texture labels into image processing.

Texture labels may be set in regions designated by the user, or a result of segmentation by simple linear iterative clustering (SLIC) or the like may be presented so that texture labels can be set in designated regions among the regions.

### Learning: Texture Segmentation Detection DNN

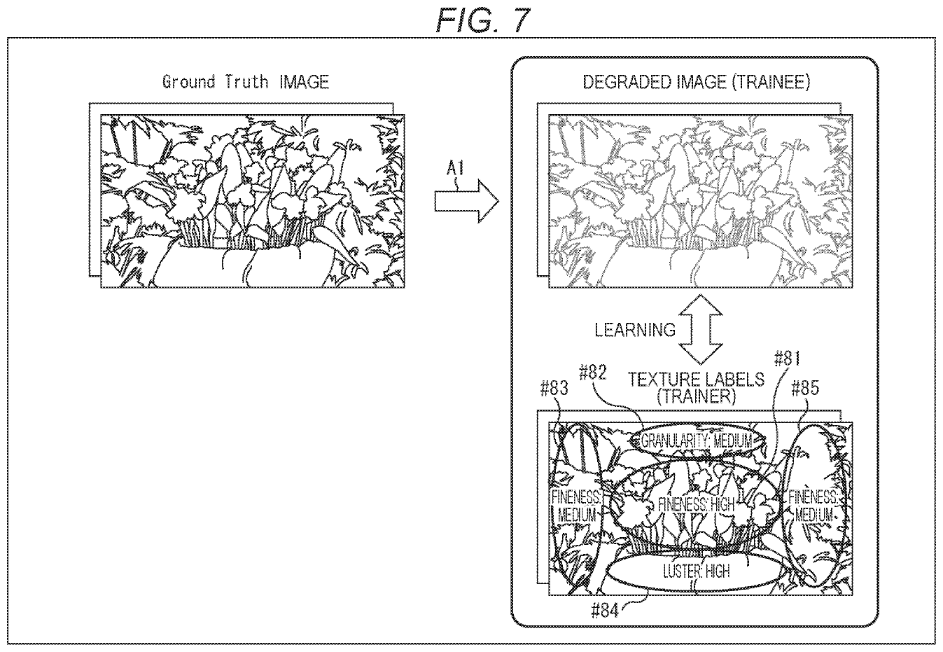

FIG. 7 is a diagram showing an example of learning of a texture segmentation detection DNN.

A texture segmentation detection DNN is a DNN that associates texture labels with the regions to be subjected to texture control.

As indicated by the portion to which an arrow A1 points in FIG. 7, learning that uses texture labels as training data and a degraded image as trainee data is performed by the DNN learning unit 14. In an example shown in FIG. 7, the texture labels set in the GT image described above with reference to B of FIG. 6, and the degraded image generated on the basis of the GT image are shown as training data and trainee data, respectively. In FIG. 7, the objects captured in the degraded image are shown in faint colors, which indicates that the resolution of the degraded image is lower than that of the GT image. The similar applies in the following drawings.

Using the texture segmentation detection DNN generated by such learning, it is possible to infer which texture labels are to be assigned to the respective regions of the image to be processed.

### Learning: Super-Resolution Processing DNN

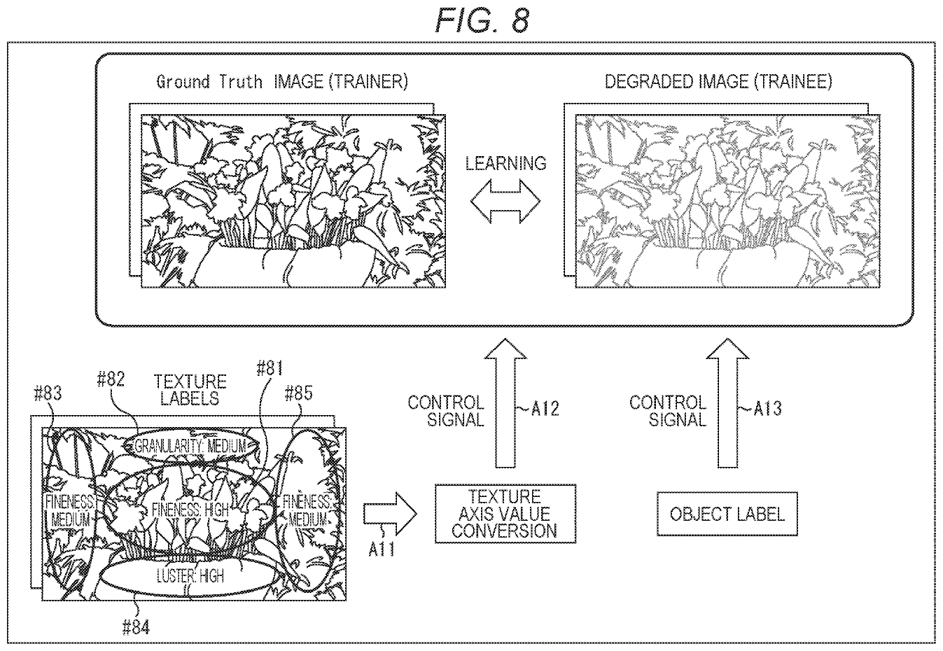

FIG. 8 is a diagram showing an example of learning of a super-resolution processing DNN.

A super-resolution processing DNN is a DNN capable of controlling a super-resolution process, using texture axis values as a control signal.

As indicated by the portion to which an arrow A11 points, a process of converting the intensities of the textures of the respective regions expressed by texture labels into texture axis values is performed by the texture axis value conversion unit 15. The learning by the DNN learning unit 17 using the GT image as the training image and the degraded image as the trainee image is performed, with control signals being the texture axis values indicated by an arrow A12 and the object label indicated by an arrow A13.

Note that the object labels to be used as a control signal for learning the super-resolution processing DNN is used for increasing the accuracy of the super-resolution process. The object labels and the texture labels are combined, and learning is performed so that a different coefficient is calculated for each combination of an object label and a texture label. Thus, classification patterns can be increased, and inference accuracy can be increased.

Only the texture labels may be used as a control signal. In this case, the object detection unit 16 can be excluded from the learning device 1.

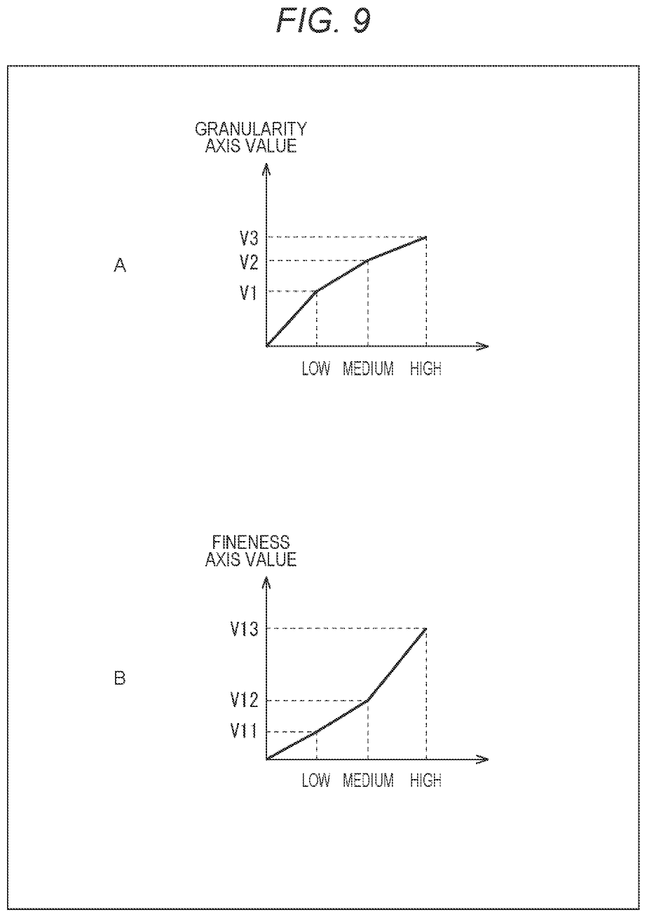

FIG. 9 is graphs showing examples of conversion of texture axis values.

A of FIG. 9 and B of FIG. 9 show conversion of texture axis values of granularity and fineness, respectively. The abscissa axis indicates the intensity of texture, and the ordinate axis indicates texture axis value. Information indicating such a correspondence relationship between intensities and texture axis values is supplied to the texture axis value conversion unit 15 for each texture label of each texture expression.

As shown in FIG. 9, reference values for the texture axis values corresponding to low, medium, high, and OFF, which are intensities of texture are set. In the example shown in A of FIG. 9, a value V1, a value V2, a value V3, and a value 0 are set as reference values for the texture axis values corresponding to the respective intensities of low, medium, high, and OFF.

When the texture label of a certain region is set as “granularity: high”, the texture axis value conversion unit 15 converts the intensity into the texture axis value V3, on the basis of the information shown in A of FIG. 9. Also, when the texture label of a certain region is set as “fineness: medium”, the texture axis value conversion unit 15 converts the intensity into the texture axis value V12, on the basis of the information shown in B of FIG. 9.

As the learning of the super-resolution processing

DNN is performed with such texture axis values being a control signal, the image processing device 2 can control the texture of each region with the texture axis values. At the time of inference in the image processing device 2, when the texture axis value is an intermediate value between two reference values, volume control is performed so as to generate an image with a texture having the intermediate intensity.

Note that the texture labels may not include intensities, and may include only the types of texture expressions. In this case, volume control corresponding to reference values for ON (labeled) and OFF (unlabeled) is performed at the time of inference.

### Inference Using DNNs

### Configuration of the Image Processing Device 2

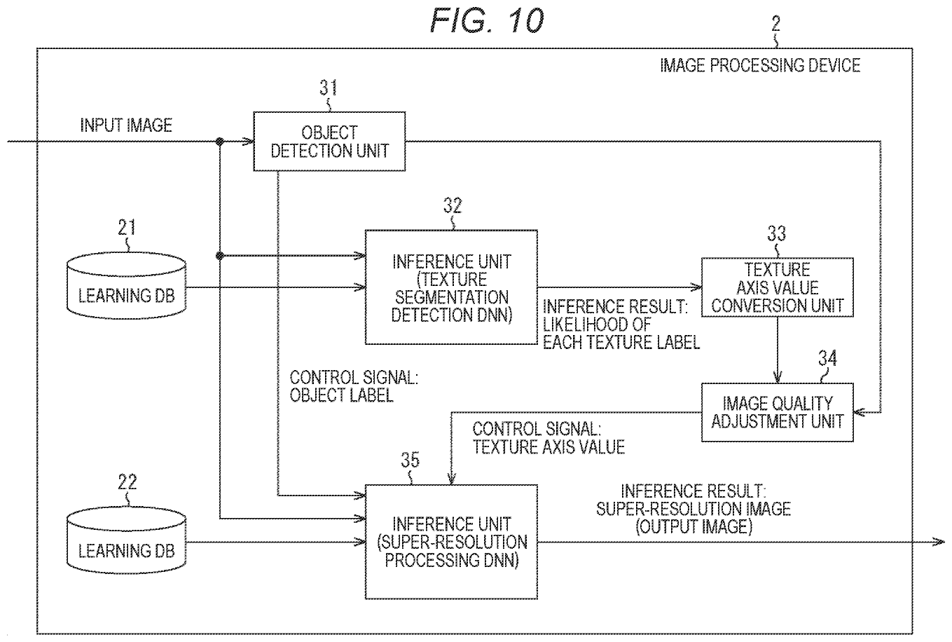

FIG. 10 is a block diagram showing an example configuration of the image processing device 2.

The image processing device 2 includes an object detection unit 31, an inference unit 32, a texture axis value conversion unit 33, an image quality adjustment unit 34, and an inference unit 35. A low-resolution image to be processed is input as an input image to the object detection unit 31, the inference unit 32, and the inference unit 35. The learning DB 21 and the learning DB 22 output from the learning device 1 are input to the inference unit 32 and the inference unit 35, respectively.

The object detection unit 31 performs processing such as semantic segmentation on the input image, to detect the objects captured in the respective regions of the input image. The object detection unit 31 outputs object labels indicating the objects captured in the respective regions, to the image quality adjustment unit 34 and the inference unit 35.

The inference unit 32 inputs the input image to a texture segmentation detection DNN, and infers texture labels expressing the textures of the respective regions. The inference unit 32 outputs the texture labels as the inference result to the texture axis value conversion unit 33. The likelihoods of the respective texture labels are also added to the texture labels as the inference result.

The inference unit 32 functions as a texture detection unit that performs inference of texture labels expressing the textures of the respective regions. As the processing for achieving the textures expressed by the texture labels inferred by the inference unit 32 is performed in the inference unit 35 and the like, and an output image is generated, the texture labels inferred by the inference unit 32 express the textures of the respective regions formed in the output image.

The texture axis value conversion unit 33 converts the intensities of the textures of the respective regions into texture axis values, on the basis of the likelihoods of the texture labels supplied from the inference unit 32. The texture axis value conversion unit 33 outputs information about the texture axis values of the respective regions to the image quality adjustment unit 34.

The image quality adjustment unit 34 adjusts the texture axis values of the respective regions obtained by the texture axis value conversion unit 33, on the basis of object labels supplied from the object detection unit 31. As the texture axis values of the respective regions are adjusted, the image quality of a high-resolution image generated by the inference performed by the inference unit 35 is adjusted.

The image quality adjustment unit 34 outputs information about the adjusted texture axis values of the respective regions to the inference unit 35. The information about the texture axis values output from the image quality adjustment unit 34 is used as an inference control signal in the inference unit 35. The image quality adjustment unit 34 functions as a control signal generation unit that generates a control signal indicating the image quality of each region formed in the output image as the inference result.

The inference unit 35 inputs the input image to a super-resolution processing DNN, and infers a high-resolution image. The inference by the inference unit 35 is performed, with the control signals being the texture axis values supplied from the image quality adjustment unit 34 and the object labels supplied from the object detection unit 31. The inference is performed with the use of the texture axis values of the respective regions and the coefficients prepared for the respective combinations of the objects captured in the respective regions.

The inference unit 35 outputs the image of the inference result as an output image. A component that performs processing using the high-resolution image generated by the inference unit 35 is provided in a stage that follows the inference unit 35. As described above, the inference unit 35 functions as an image generation unit that inputs the input image to the super-resolution processing DNN and infers a high-resolution image in which the textures expressed by the texture axis values are achieved in the respective regions.

The processes to be performed by the respective components of the image processing device 2 are described below in detail.

### Inference: Texture Segmentation Detection DNN

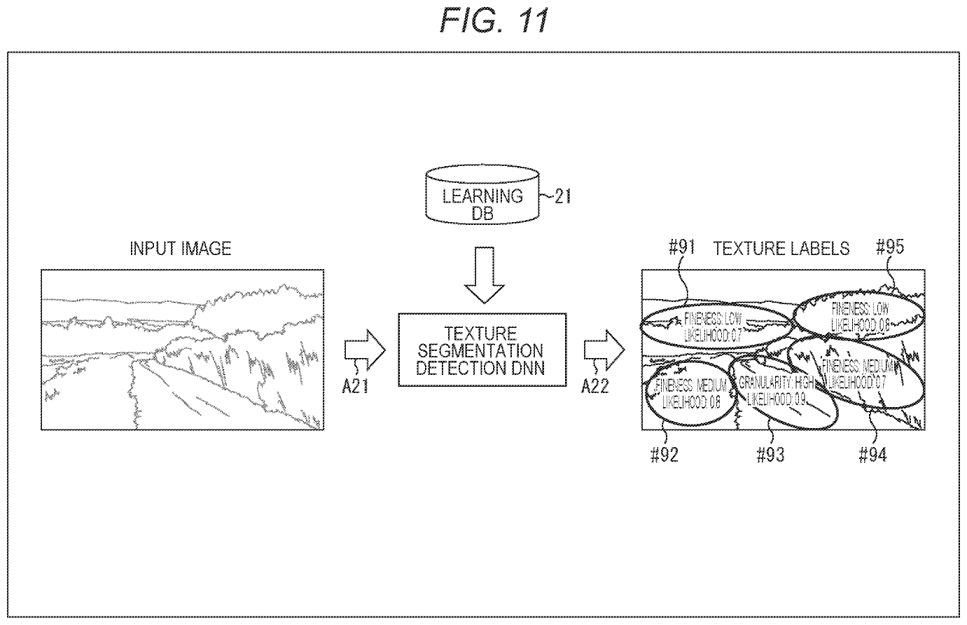

FIG. 11 is a diagram showing an example of inference using a texture segmentation detection DNN.

As indicated by an arrow A21, an input image that is a low-resolution image is used as an input to a texture segmentation detection DNN by the inference unit 32, and texture labels to which an arrow A22 points are output.

In the example shown in FIG. 11, a texture label “fineness: low” is set in an upper left region #91 in which a distant landscape is captured. The likelihood of the texture label of the region #91 is 0.7.

Likewise, a texture label “fineness: medium” is set in a lower left region #92 in which grass on a gravel road side is captured, and a texture label “granularity: high” is set in a lower central region #93 in which a gravel road is captured. A texture label “fineness: medium” is set in a lower right region #94 in which grass on a gravel road side is captured, and a texture label “fineness: low” is set in an upper right region #95 in which a distant landscape is captured. The likelihoods of the texture labels of the regions #92 to #95 are 0.8, 0.9, 0.7, and 0.8, respectively.

In this manner, the texture labels of the respective regions and the likelihoods of the texture labels represented by the values between 0.0 and 1.0 are output from the texture segmentation detection DNN.

The inference using the texture segmentation detection DNN is performed so that the sum of the likelihoods of the texture labels assigned to each region is 1.0.

For example, although “fineness: low” is shown as the texture label of the region #91, and the likelihood thereof is 0.7, texture labels with different intensities of “fineness: medium”, “fineness: high”, and “fineness: OFF” are also assigned to the region #91, and the likelihoods thereof are also obtained. The sum of the likelihood of the texture label “fineness: medium”, the likelihood of the texture label “fineness: high”, and the likelihood of the texture label “fineness: OFF” is 0.3.

### Texture Axis Value Conversion

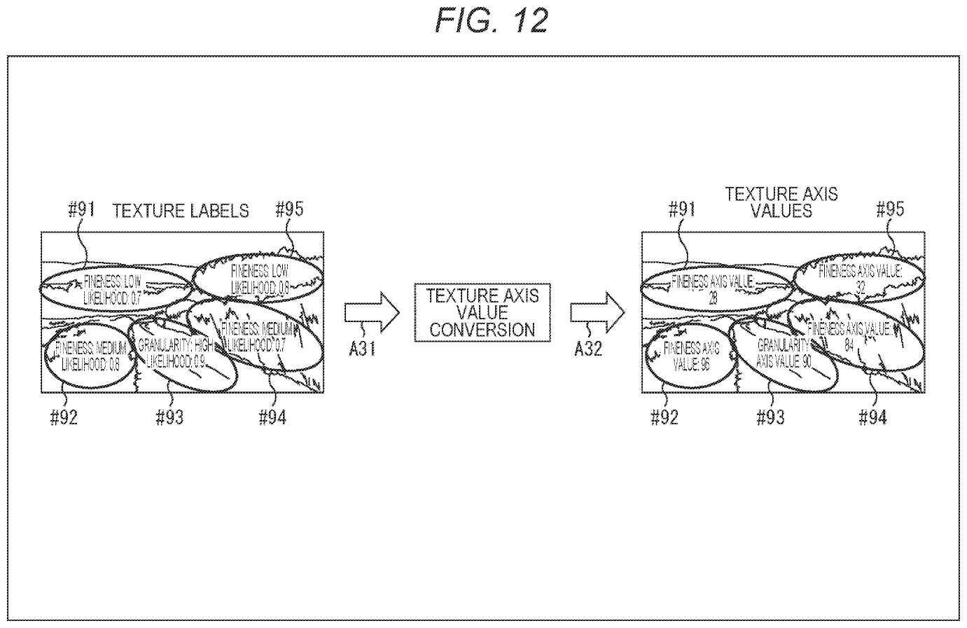

FIG. 12 is a diagram showing an example of conversion of texture axis values.

In the texture axis value conversion unit 33, the intensities of the textures expressed by the texture labels in the respective regions are converted into texture axis values. Information indicating the correspondence relationship between intensities and texture axis values as described with reference to FIG. 9 is supplied to the texture axis value conversion unit 33.

When the texture labels in FIG. 11 are obtained by inference and are supplied as indicated by an arrow A31 in FIG. 12, the intensities of the textures of the respective regions are converted into texture axis values to which an arrow A32 points. In the example shown in FIG. 12, the intensities of the textures of the respective regions #91 to #95 are converted into texture axis values of 28, 96, 90, 84, and 32. Note that the numerical values of these texture axis values are merely an example of conversion, and are obtained by multiplying the reference values (a reference value of 40 for “fineness: low”, a reference value of 120 for “fineness: medium”, and a reference value of 100 for “granularity: high”) by the likelihoods. In practice, the texture axis values are obtained, with the reference values for the other intensities being taken into consideration.

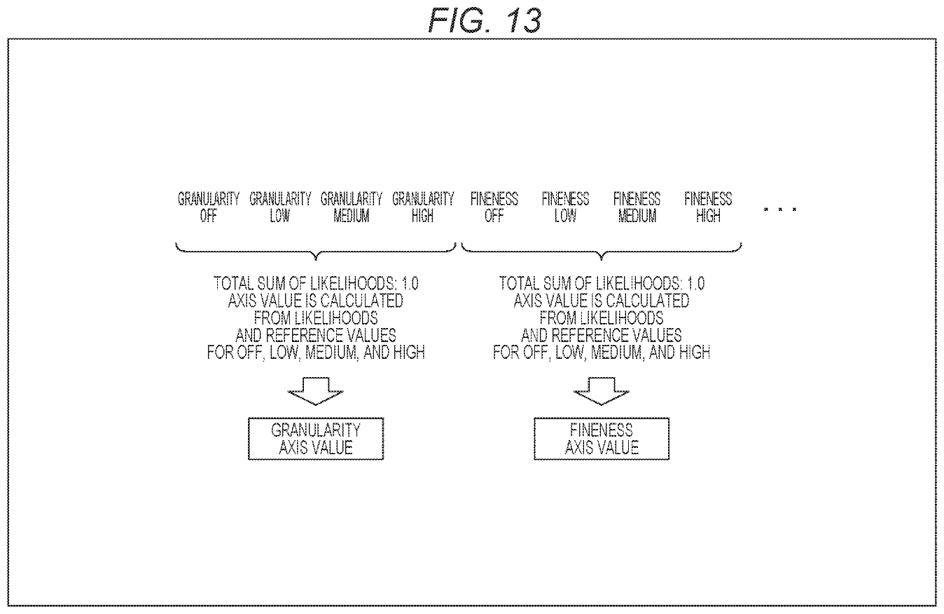

FIG. 13 is a diagram showing an example of calculation of texture axis values.

As shown in FIG. 13, the calculation of texture axis values is performed on the basis of the likelihood of each texture label of the same texture expression and the reference values for texture axis values. The reference values for texture axis values are obtained on the basis of information indicating the correspondence relationship between intensities and texture axis values.

For example, a texture axis value of granularity is obtained by multiplying the reference value corresponding to “granularity: low”, the reference value corresponding to “granularity: medium”, the reference value corresponding to “granularity: high”, and the reference value corresponding to “granularity: OFF” by the respective likelihoods, and adding up the resultant values.

### Image Quality Adjustment

The texture axis values obtained by the texture axis value conversion unit 33 are adjusted by the image quality adjustment unit 34 in accordance with an object label. The texture axis values adjusted by the image quality adjustment unit 34 form a control signal at the time of inference using a super-resolution processing DNN.

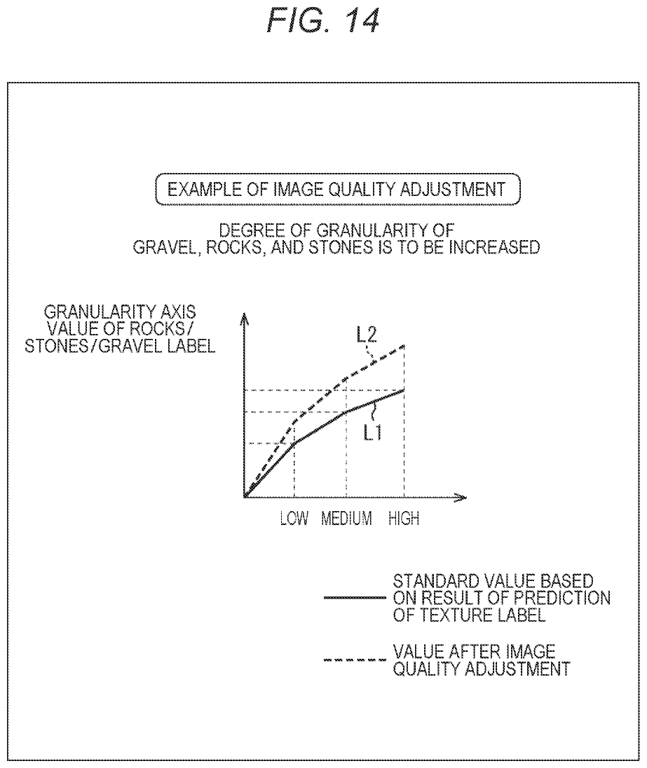

FIG. 14 is a diagram showing an example of adjustment of texture axis values.

A solid line L1 in FIG. 14 indicates a standard correspondence relationship that is used for conversion of texture axis values of granularity. On the basis of the standard correspondence relationship, the texture axis value conversion unit 33 obtains texture axis values of granularity.

A dashed line L2 indicates the correspondence relationship after adjustment. In the example shown in FIG. 14, adjustment is performed so that higher values than the standard correspondence relationship are required as the reference values corresponding to the respective intensities of granularity. Such a correspondence relationship between intensities of texture and texture axis values is set for each object label. The correspondence relationship indicated by the dashed line L2 indicates the correspondence relationship for rocks, stones, and sand.

In the image quality adjustment unit 34, the texture axis values of the granularity in a region in which an object label of rocks, stones, and sand is set is adjusted to a value corresponding to the correspondence relationship indicated by the dashed line L2. As a result, inference is performed to further enhance the granularity of the region in which rocks, stones, and sand are captured.

By enabling adjustment of the texture axis values of the respective regions, which are the intensities of texture, in accordance with the objects captured in the respective regions, it is possible to create an image of each object in such a manner that the fineness of a forest differs from the fineness of the fur of an animal.

Also, by lowering the degree of fineness of distant trees and forests while increasing the degree of fineness of nearby trees and forests, it is possible to express textures such as farness/nearness and depth. For example, it is possible to obtain such texture expressions by lowering the texture axis value of fineness for a region in which an object label of distant trees and forests is set, to a lower value than the reference value at the time of learning, and raising the texture axis value of fineness for a region in which an object label of nearby trees and forests is set, to a higher value than the reference value at the time of learning. As for the object distances, depth detection or the like is used.

When textures such as granularity and fineness are controlled by a conventional technique, the control is performed by combining a super-resolution process, an enhancement process, a contrast/color adjustment process, and the like. However, the ability of expression is low, and the textures are not directly controlled. By the process described above, it is possible to directly control textures, and enable an inference for each object.

Further, even in regions in which the same object is captured, the texture to be controlled varies with each portion. By the process described above, it is possible to control the texture for each region of an object. Such texture control using object detection is performed when an output image of the image processing device 2 is used for display on a display device such as a TV set, for example.

### Inference: Super-Resolution Processing DNN

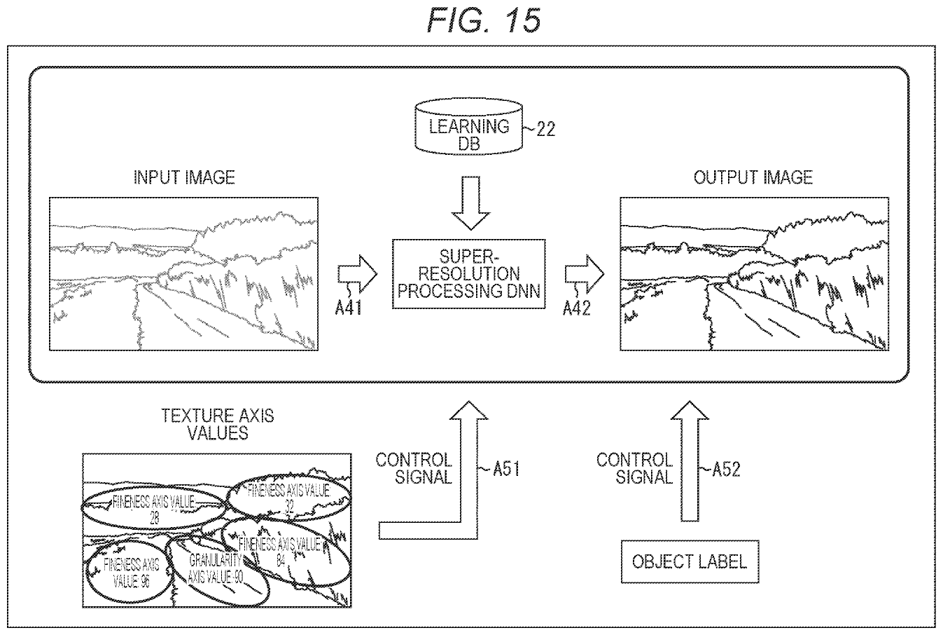

FIG. 15 is a diagram showing an example of inference using a super-resolution processing DNN.

As indicated by an arrow A41, an input image that is a low-resolution image is used as an input to a super-resolution processing DNN by the inference unit 35, and a high-resolution image to which an arrow A42 points is output. The inference by the inference unit 35 is performed, with control signals being the texture axis values indicated by an arrow A51 and the object label indicated by an arrow A52.

### Operation of the Image Processing System

A series of operations of the learning device 1 and the image processing device 2 having the above configurations are now described.

### Operation of the Learning Device 1

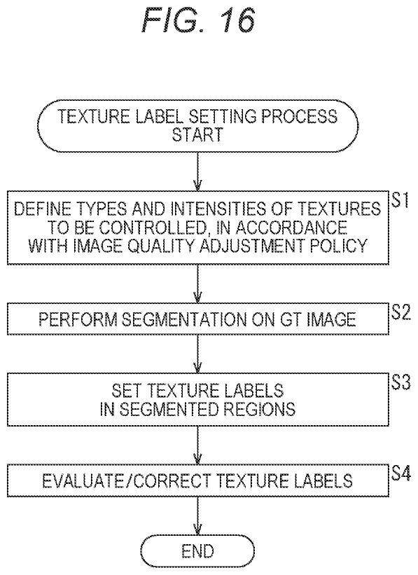

Referring now to a flowchart in FIG. 16, a texture label setting process to be performed by the learning device 1 is described.

In step S1, the texture label definition unit 11 of the learning device 1 defines the types and intensities of the textures to be controlled in accordance with an image quality adjustment policy or the like.

In step S2, the object detection unit 16 performs semantic segmentation on a GT image, and detects the objects captured in the respective regions of the GT image.

In step S3, the texture label assignment processing unit 12 sets a texture label in each segmented region, in accordance with settings made by the user.

In step S4, the texture label assignment processing unit 12 evaluates/corrects the texture labels as appropriate.

The above process is performed on various GT images, and texture labels of the amounts necessary for learning a DNN are generated.

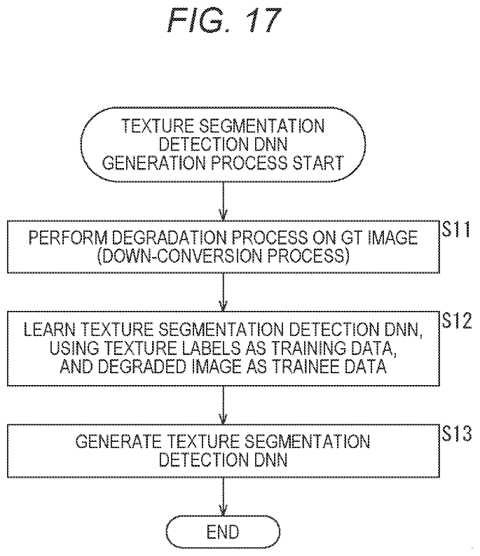

Referring now to a flowchart in FIG. 17, a texture segmentation detection DNN generation process to be performed by the learning device 1 is described.

In step S11, the degradation processing unit 13 performs a degradation process on a GT image.

In step S12, the DNN learning unit 14 performs learning, with the texture labels being the training data, and the degraded image being the trainee data. The learning by the DNN learning unit 14 is repeated until a sufficient accuracy is achieved.

In step S13, the DNN learning unit 14 generates a texture segmentation detection DNN on the basis of the results of the learning. Information about the coefficients and the like of the respective layers constituting the texture segmentation detection DNN is output as the learning DB 21 to the image processing device 2.

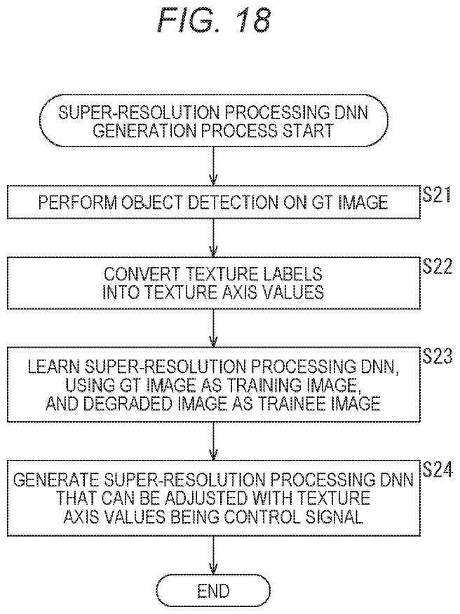

Referring now to a flowchart in FIG. 18, a super-resolution processing DNN generation process to be performed by the learning device 1 is described.

In step S21, the object detection unit 16 performs semantic segmentation on a GT image, and detects the objects captured in the respective regions of the GT image.

In step S22, the texture axis value conversion unit 15 converts the intensities of the textures of the respective regions into texture axis values, on the basis of the texture labels.

In step S23, the DNN learning unit 17 performs learning, with the GT image being the training image, and the degraded image being the trainee image. The learning by the DNN learning unit 17 is repeated until a sufficient accuracy is achieved.

In step S24, on the basis of the results of the learning, the DNN learning unit 17 generates a super-resolution processing DNN that can be adjusted, with the texture axis values and the object labels being control signals. Information about the coefficients and the like of the respective layers constituting the super-resolution processing DNN is output as the learning DB 22 to the image processing device 2.

### Operation of the Image Processing Device 2

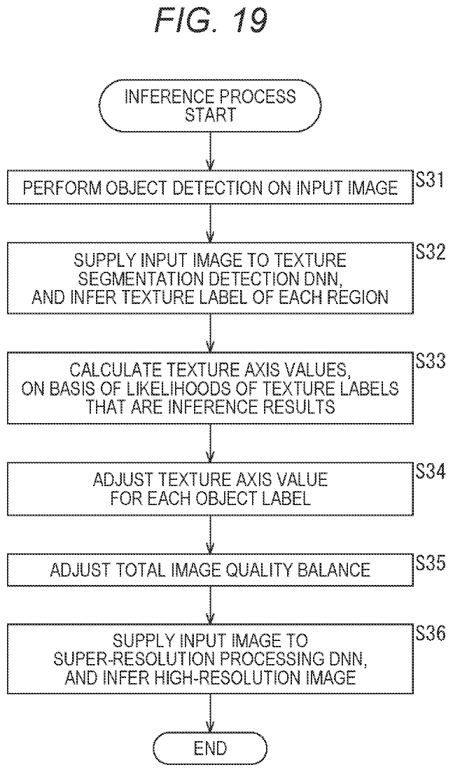

Next, an inference process to be performed by the image processing device 2 is described, with reference to a flowchart in FIG. 19.

In step S31, the object detection unit 31 of the image processing device 2 performs semantic segmentation on an input image, and detects the objects captured in the respective regions of the input image.

In step S32, the inference unit 32 inputs the input image to a texture segmentation detection DNN, and infers texture labels expressing the textures of the respective regions.

In step S33, the texture axis value conversion unit 33 converts the intensities of the textures of the respective regions into texture axis values, on the basis of the likelihoods of the texture labels. As described above with reference to FIG. 13 and others, the texture axis values are calculated on the basis of the likelihoods of the respective texture labels as the results of the inference.

In step S34, the image quality adjustment unit 34 adjusts the texture axis values of the respective regions in accordance with object labels.

In step S35, the image quality adjustment unit 34 adjusts the balance of the total image quality. The image quality balance is adjusted as appropriate through adjustment of the texture axis values. The adjustment of the texture axis values for adjusting the image quality balance will be described later.

In step S36, the inference unit 35 inputs the input image to a super-resolution processing DNN, and infers a high-resolution image to be an output image. The inference by the inference unit 35 is performed, with the control signals being the texture axis values supplied from the image quality adjustment unit 34 and the object labels supplied from the object detection unit 31.

As described above, the image processing system can perform a super-resolution process capable of directly controlling textures, by performing learning of DNNs and inference using DNNs on the basis of texture labels expressing qualitative feelings of human beings.

Since the super-resolution process to be performed in the image processing system is a process specializing in assigning an optimum texture to each region, it can be said that the image restoration/generation capability is high in the process. A general-purpose super-resolution process without involving any specialized process is a process that is likely to lead to an average solution, but such a situation can be prevented. That is, the image processing system can generate an image in which an appropriate texture is expressed in each region.

### Examples of Label Settings

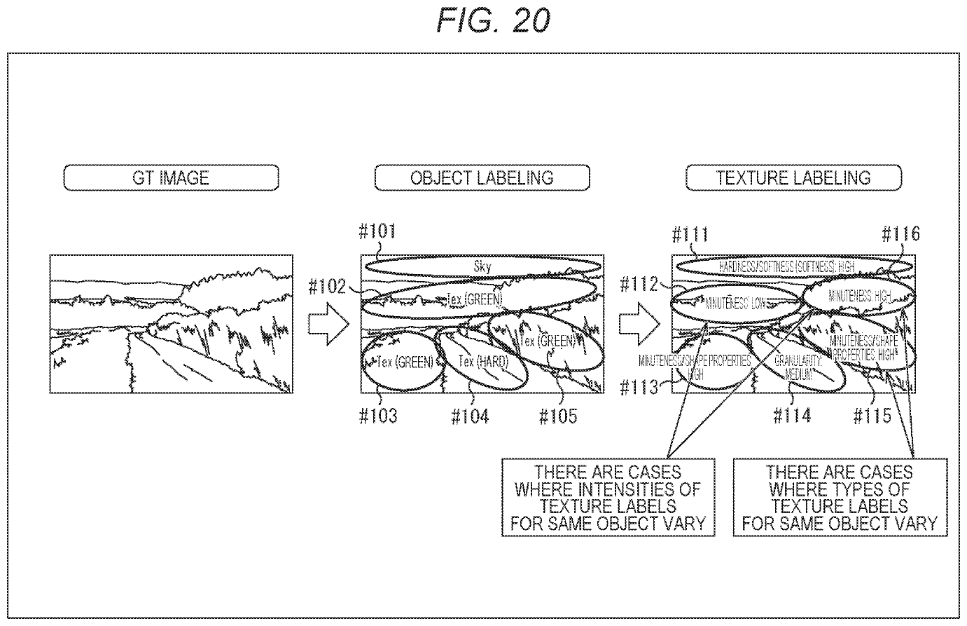

FIGS. 20 to 22 are diagrams showing examples of settings of object labels and texture labels.

Images shown at the left sides in FIGS. 20 to 22 are GT images to be subjected to label settings. Object detection is performed on the GT images, and the objects captured in the respective regions are detected. For each of the regions in which the objects are captured, object labels as shown at the centers of FIGS. 20 to 22 are set by the object detection unit 16 during the DNN learning.

In the example shown in FIG. 20, in the GT image, an object label “Sky” is set in a region #101 in which the sky is captured, and an object label “Texture (green)” is set in regions #102 to #105 that are the other regions.

When such object labels are set, texture labels with different intensities might be set in regions in which the same object is captured (regions in which the same object label is set) as shown in the dialog boxes at the right side in FIG. 20. Also, texture labels with different types of texture expressions might be set in regions in which the same object is captured.

In the example in FIG. 20, a texture label “minuteness: low” and a texture label “minuteness: high” with different intensities are set in a region #112 and a region #116, respectively, which correspond to the region #102 in which the same object label “Texture (green)” is set.

Also, a texture label “minuteness/shape properties: high” and a texture label “minuteness: high” with different types of texture expressions are set in a region #115 and the region #116, respectively, which correspond to the regions in which the same object label “Texture (green)” is set.

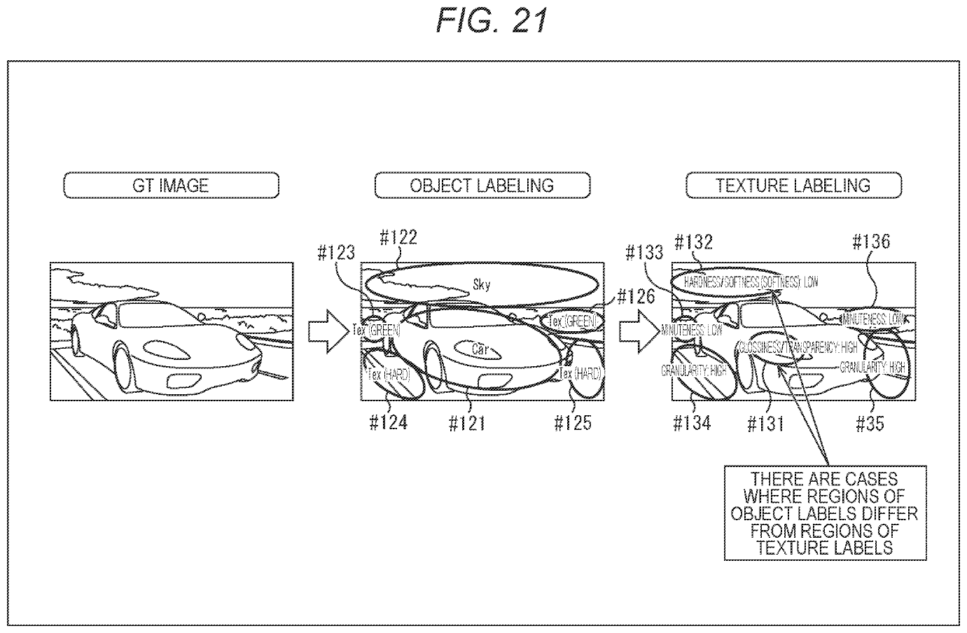

In the example shown in FIG. 21, in the GT image, an object label “Car” is set in a region #121 in which a car is captured, and an object label “Sky” is set in a region #122 in which the sky is captured. An object label is also set in each of the regions #123 to #126, which are the other regions.

When such object labels are set, the regions in which the object labels are set might differ from the regions in which texture labels are set, as shown in a dialog box at the right side in FIG. 21.

In the example in FIG. 21, a texture label “glossiness/transparency: high” is set in a region #131 that is part of the region #121 in which the object label “Car” is set. Also, a texture label “hardness/softness (softness): low” is set in a region #132 that is part of the region #122 in which the object label “Sky” is set.

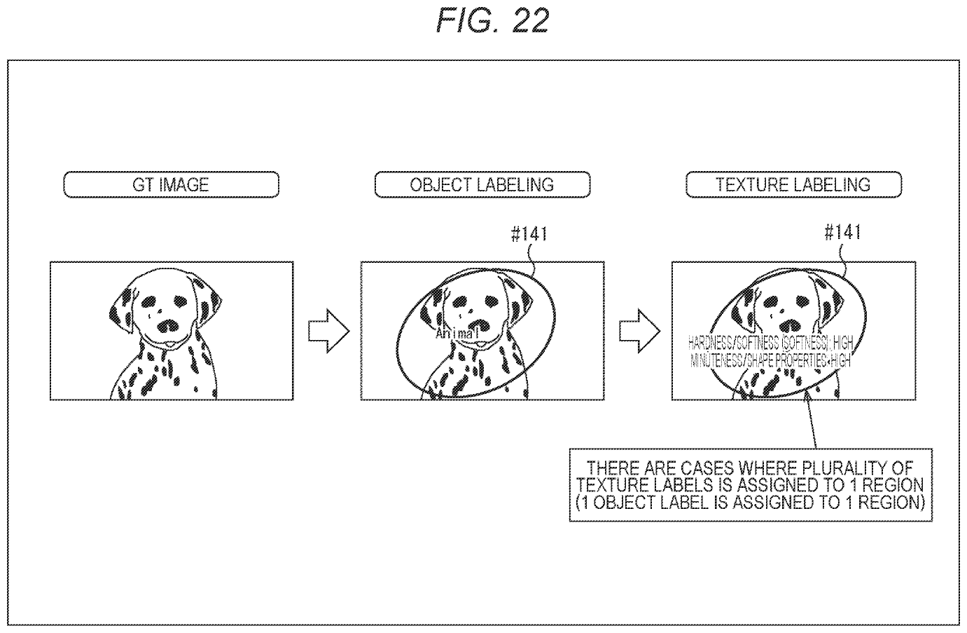

In the example in FIG. 22, in the GT image, an object label “Animal” is set in a region #141 in which a dog is captured.

When such an object label is set, a plurality of types of texture labels might be set in one region, as shown in a dialog box at the right side in FIG. 22. As for object labels, only one type of object label is set in one region.

In the example shown in FIG. 22, a texture label “hardness/softness (softness): high” and a texture label “minuteness/shape properties: high” are set in the same region as the region #141 in which the object label “Animal” is set.

By performing learning on the basis of such texture labels, it is possible to generate a texture segmentation detection DNN capable of expressing various textures.

Note that texture labels that are the results of inference using a texture segmentation detection DNN also express the textures of the respective regions as described above.

### Example Applications

### Example Application 1: Image Quality Adjustment for Creators

Although the texture axis values obtained on the basis of texture labels that are the results of inference of a texture segmentation detection DNN are used as a control signal for a super-resolution processing DNN in the above description, a user may designate any desired information corresponding to the texture axis values.

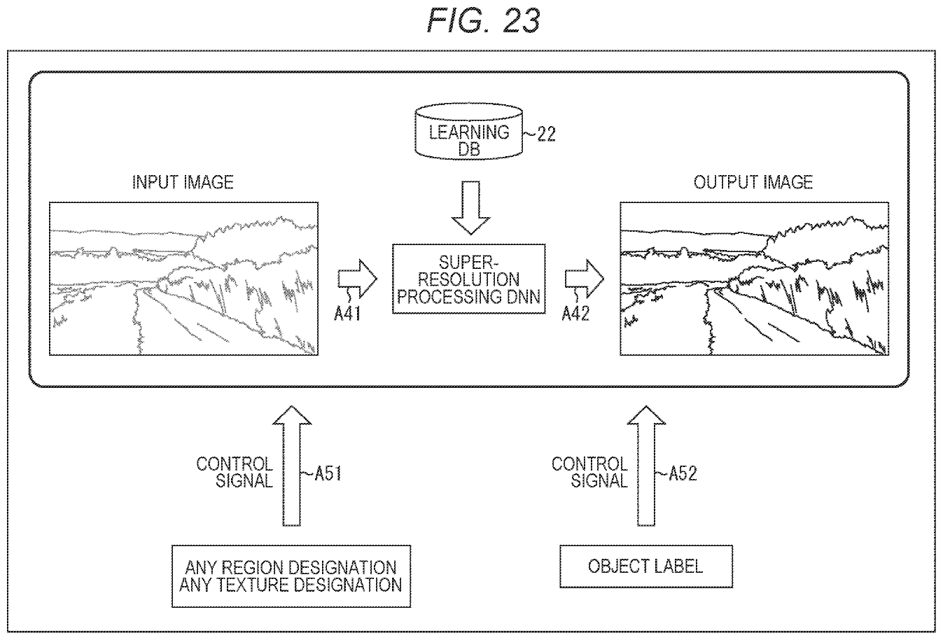

In this case, a desired texture is designated by the user for any region of an input image, and a signal indicating the designation by a user is used as a control signal for a super-resolution processing DNN, as indicated by an arrow A51 in FIG. 23.

Some users wish to designate textures of the respective regions. A function in which a user can designate information corresponding to the texture axis values is a function for users such as creators. With this arrangement, image quality adjustment with a high degree of freedom can be performed.

Such image quality adjustment in accordance with a user's operation is performed as adjustment of the image quality balance in step S35 in FIG. 19, for example. A control signal indicating the content after the balance adjustment is used as a control signal for the super-resolution processing DNN.

The texture labels obtained as a result of inference of the texture segmentation detection DNN may be presented as a guide to the user who designates textures of the respective regions.

### Example Application 2: Labeling Specialized in a Use Case at an Output Destination

Image quality labels expressing image qualities different from textures may be used in learning of a DNN. In this case, instead of a texture segmentation detection DNN, a DNN that associates the image quality labels with the regions to be subjected to image quality control is generated in the learning device 1.

For example, image quality labels are set in accordance with the use case at the output destination of an output image that is a result of inference performed by the inference unit 35.

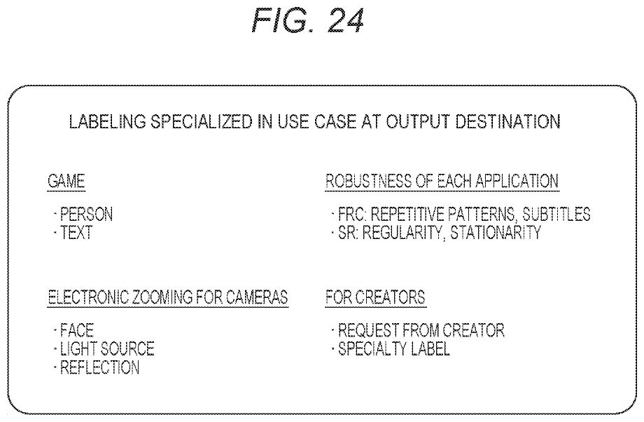

FIG. 24 is a diagram showing an example of image quality labels.

When an output image that is an inference result is used in a game, labels indicating a region in which a person is captured and a region in which text is shown are set as image quality labels.

When an output image that is an inference result is used in electronic zooming for cameras, labels indicating a face region, a light source region, and a reflection region are set as image quality labels.

When an output image is used in frame rate control (FRC) to increase the robustness of an application (a use case at the output destination), labels indicating a region in which repetitive patterns are shown and a region of subtitles are set as image quality labels. Further, when an output image is used in a super-resolution process, labels indicating a region in which regularity is seen and a region in which stationarity is seen are set as image quality labels.

Any desired labels regarding image quality may be set as image quality labels for creators.

As labels are changed in this manner, desired image creation can be realized. Except that the labels are different, processes similar to the processes described above are performed in the image processing system.

### Example Application 3: Use of Image Creation Labels

As the intent of image creation is added to texture labels, a user can enable learning of a DNN with which inference taking the intent of image creation into consideration can be performed. Texture labels to which the intent of image creation is added are set prior to DNN learning.

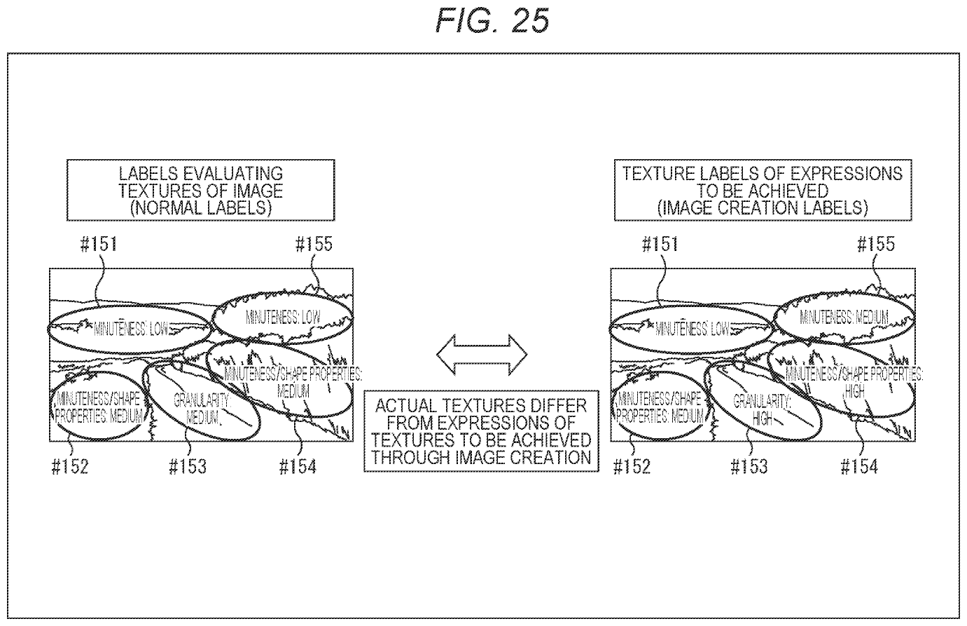

FIG. 25 is a diagram showing an example of texture labels to which the intent of image creation is added.

Each of the texture labels in regions #151 to #155 shown on the left side in FIG. 25 is a normal texture label that is set by evaluating the texture corresponding to the actual appearance.

On the other hand, each of the texture labels in regions #151 to #155 shown on the right side in FIG. 25 is a texture label to which the intent of image creation is added. Texture labels to which the intent of image creation is added include texture labels with different intensities from those of normal texture labels.

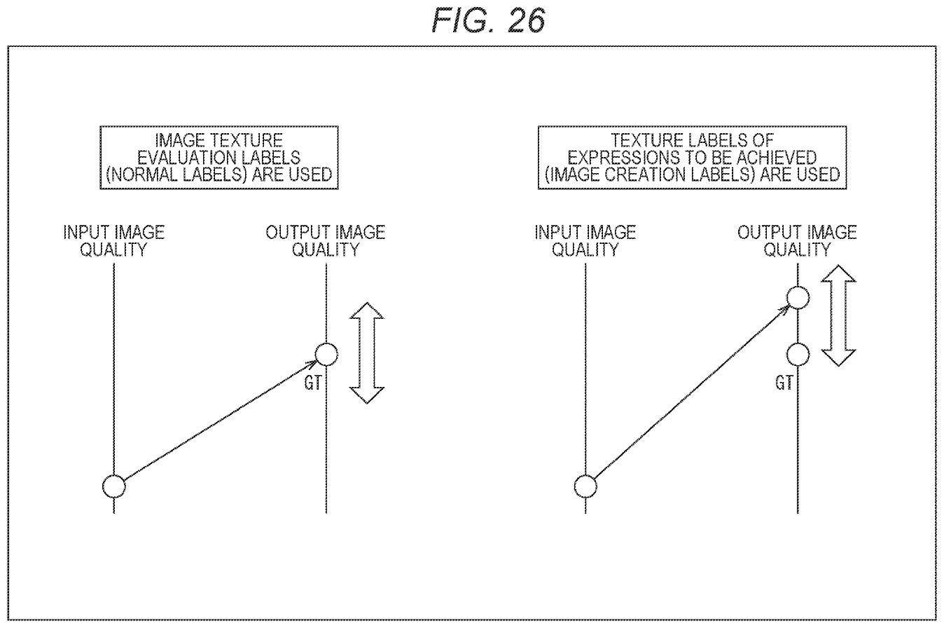

FIG. 26 is a diagram schematically showing the image quality of a result of inference using texture labels to which the intent of image creation is added.

As indicated by open arrows on the left side in FIG. 26, the target image quality of the output image obtained as the eventual output when a DNN generated on the basis of normal texture labels is used is the image quality of a GT image.

By using a DNN generated on the basis of texture labels to which the intent of image creation is added, it is possible to achieve image quality expressions different from those of the GT image, in terms of the image quality of the output image, as indicated by open arrows on the right side in FIG. 26.

### Example Application 4: Image Processing Other Than a Super-Resolution Process

Instead of a super-resolution processing DNN, a DNN for image processing different from a super-resolution process, such as a contrast/color adjustment process, an SDR-HDR conversion process, and an enhancement process, may be used in the image processing device 2.

As a process for expressing textures such as glossiness, transparency, luster, shine, and shadowiness, image processing such as a contrast/color adjustment process and an SDR-HDR conversion process is compatible processing. When an enhancement process is performed, labeling may be performed not on texture labels but on objects or regions in which priority is given to enhancement adjustment.

DNN learning is performed with the use of an image different from the image used in the learning of a super-resolution processing DNN.

For example, learning of a DNN for a contrast/color adjustment process is performed, with the training image being a GT image, and the trainee image being a degraded image formed by weakening the contrast and lowering the saturation in the GT image. The image processing to be performed by the degradation processing unit 13 is a process of weakening the contrast and lowering the saturation.

Learning of a DNN for an SDR-HDR conversion process is performed, with the training image being an HDR image, and the trainee image being the SDR image obtained by performing tone mapping as a degradation process on the HDR image. The image processing to be performed by the degradation processing unit 13 is a process of converting an HDR image into an SDR image.

Learning of a DNN for an enhancement process is performed, with the training image being a GT image, and the trainee image being a degraded image obtained by removing the high-frequency components from the GT image. The image processing to be performed by the degradation processing unit 13 is a process of removing high-frequency components from the GT image.

Instead of a DNN for a single process, a DNN for image processing that combines a plurality of processes, such as a super-resolution process and a contrast/color adjustment process, or an SDR-HDR conversion process and an enhancement process, may be learned and used in inference.

### Example Application 5: an Example in Which a Texture Segmentation Detection DNN Is Used as a Texture Evaluation Model

A GT image may be input to a texture segmentation detection DNN, and the texture labels of the respective regions of the GT image may be inferred.

The texture labels as the inference result are presented to the user, and are used for evaluating the textures of the respective regions. For example, the user can perform inference on the basis of the GT image before image creation and the GT image after image creation, and check how the image creation changes the textures.

In this example, the texture segmentation detection DNN is used as a DNN for texture evaluation. The learning of the DNN for texture evaluation is performed, with the training data being the texture labels, and the trainee data being the GT image.

### Example Application 6: Semi-Supervised Learning

A texture segmentation detection DNN using a GT image as an input image may be learned through semi-supervised learning. In this case, the texture labels that are the result of inference performed by inputting the GT image to the texture segmentation detection DNN are used as the training data.

This learning is effective when there are a small number of texture labels serving as the training data. The inference result may not be directly used as the training data, but the result as the texture labels may be evaluated manually and be corrected if necessary, to increase inference accuracy.

### Other Example

### Example Configuration of a Computer

The series of processes described above can be performed by hardware, and can also be performed by software. When the series of processes are performed by software, the program that forms the software may be installed in a computer incorporated into special-purpose hardware, or may be installed from a program recording medium into a general-purpose personal computer or the like.

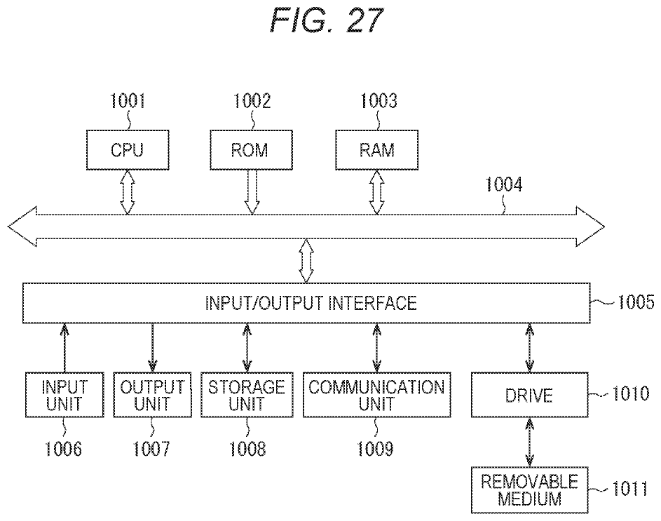

FIG. 27 is a block diagram showing an example configuration of the hardware of a computer that performs the above series of processes according to a program.

A central processing unit (CPU) 1001, a read only memory (ROM) 1002, and a random access memory (RAM) 1003 are connected to one another by a bus 1004.

An input/output interface 1005 is further connected to the bus 1004. An input unit 1006 formed with a keyboard, a mouse, and the like, and an output unit 1007 formed with a display, a speaker, and the like are connected to the input/output interface 1005. Further, a storage unit 1008 formed with a hard disk, a nonvolatile memory, or the like, a communication unit 1009 formed with a network interface or the like, and a drive 1010 that drives a removable medium 1011 are connected to the input/output interface 1005.

In the computer having the above described configuration, the CPU 1001 loads a program stored in the storage unit 1008 into the RAM 1003 via the input/output interface 1005 and the bus 1004, for example, and executes the program, so that the above described series of processes are performed.

The program to be executed by the CPU 1001 is recorded in the removable medium 1011 and is thus provided, for example, or is provided via a wired or wireless transmission medium, such as a local area network, the Internet, or digital broadcasting. The program is then installed into the storage unit 1008.

The program to be executed by the computer may be a program for performing processes in chronological order in accordance with the sequence described in this specification, or may be a program for performing processes in parallel or performing a process when necessary, such as when there is a call.

Note that, in this specification, a system means an assembly of components (devices, modules (parts), and the like), and not all the components need to be provided in the same housing. In view of this, a plurality of devices that are housed in different housings and are connected to one another via a network forms a system, and one device having a plurality of modules housed in one housing is also a system.

The advantageous effects described in this specification are merely examples, and the advantageous effects of the present technology are not limited to them or may include other effects.

Embodiments of the present technology are not limited to the embodiments described above, and various modifications can be made to them without departing from the scope of the present technology.

For example, the present technology can be embodied in a cloud computing configuration in which one function is shared among a plurality of devices via a network, and processing is performed by the devices cooperating with one another.

Further, the respective steps described with reference to the flowcharts described above can be carried out by one device, or can be shared among a plurality of devices.

Furthermore, when a plurality of processes is included in one step, the plurality of processes included in the one step can be performed by one device, or can be shared among a plurality of devices.

### Example Combinations of Configurations The present technology can also be embodied in the configurations described below.

(1)

An image processing device including:

a control signal generation unit that generates a control signal indicating a texture of each region formed in an output image as an inference result, on the basis of an input image to be processed; and

an image generation unit that inputs the input image to an inference model, and infers the output image in which each region has a texture indicated by the control signal, the inference model being obtained by performing learning based on a trainee image and a training image, the trainee image being generated by performing predetermined image processing on the training image, the texture of each region being expressed by a texture label in the training image.

(2)

The image processing device according to (1), further including

a texture detection unit that inputs the input image to another inference model, and infers the texture label expressing the texture of each region formed in the output image, the another inference model being obtained by performing learning with trainee data and training data, the trainee data being an image generated by performing the predetermined image processing on an image for learning, the training data being a texture label expressing a texture of each region of the image for learning, in which

the control signal generation unit generates the control signal on the basis of the texture label that is an inference result.

(3)

The image processing device according to (2), in which

a plurality of types of texture labels expressing qualitative textures and texture intensities is defined.

(4)

The image processing device according to (3), further including

a conversion unit that converts a texture intensity expressed by the texture label inferred as the inference result with the another inference model into a numerical value, on the basis of a likelihood, in which

the control signal generation unit generates the control signal indicating a type of the texture expressed by the texture label as the inference result, and the numerical value.

(5)

The image processing device according to (4), in which

the control signal generation unit adjusts a relationship between the texture intensity and the numerical value, in accordance with an object included in each region.

(6)

The image processing device according to (1), in which

the control signal generation unit generates the control signal corresponding to a texture of each region, the texture being designated by a user.

(7)

The image processing device according to any one of (1) to (6), further including

an object detection unit that detects an object included in the input image, in which

the learning of the inference model is performed by learning a coefficient that varies with each object included in the training image, and

the image generation unit inputs the input image to the inference model in which a coefficient corresponding to an object included in the input image is set, and infers the output image.

(8)

The image processing device according to any one of (1) to (7), in which

the texture of each region is expressed with a texture of an object included in each region.

(9)

An image processing method implemented by an image processing device, the image processing method including:

generating a control signal indicating a texture of each region formed in an output image as an inference result, on the basis of an input image to be processed; and

inputting the input image to an inference model, and inferring the output image in which each region has a texture indicated by the control signal, the inference model being obtained by performing learning based on a trainee image and a training image, the trainee image being generated by performing predetermined image processing on the training image, the texture of each region being expressed by a texture label in the training image.

(10)

A program for causing a computer to perform a process of:

generating a control signal indicating a texture of each region formed in an output image as an inference result, on the basis of an input image to be processed; and

inputting the input image to an inference model, and inferring the output image in which each region has a texture indicated by the control signal, the inference model being obtained by performing learning based on a trainee image and a training image, the trainee image being generated by performing predetermined image processing on the training image, the texture of each region being expressed by a texture label in the training image.

(11)

A learning device including:

an acquisition unit that acquires a texture label indicating a texture of each region of an image for learning; and

a learning unit that generates an inference model by performing learning in accordance with a control signal indicating the texture of each region of the image for learning, using a trainee image and a training image, the trainee image being generated by performing predetermined image processing on the image for learning, the training image being the image for learning.

(12)

The learning device according to (11), further including

another learning unit that performs learning using trainee data and training data, and generates another inference model, the trainee data being an image generated by performing the predetermined image processing on the image for learning, the training data being the texture label indicating the texture of each region of the image for learning.

(13)

The learning device according to (12), in which a plurality of types of texture labels expressing qualitative textures and texture intensities is defined.

(14)

The learning device according to (13), further including

a conversion unit that converts a texture intensity indicated by the texture label indicating the texture of each region of the image for learning into a numerical value, in which

the learning unit learns the inference model in accordance with the control signal indicating a type of the texture indicated by the texture label indicating the texture of each region of the image for learning and the numerical value.

(15)

The learning device according to any one of (11) to (14), further including

an object detection unit that detects an object included in the image for learning, in which

the learning unit learns the inference model by calculating a coefficient that varies with each object included in the image for learning.

(16)

The learning device according to any one of (11) to (15), further including

an image processing unit that performs a degradation process as the predetermined image processing on the image for learning.

(17)

The learning device according to any one of (11) to (16), in which

the acquisition unit acquires a texture label indicating a texture of each region of the image for learning, the texture label being set in accordance with an operation performed by a user.

(18)

A generation method implemented by a learning device, the generation method including:

acquiring a texture label indicating a texture of each region of an image for learning; and

generating an inference model by performing learning in accordance with a control signal indicating the texture of each region of the image for learning, using a trainee image and a training image, the trainee image being generated by performing predetermined image processing on the image for learning, the training image being the image for learning.

(19)

A program for causing a computer to perform a process of:

acquiring a texture label indicating a texture of each region of an image for learning; and

generating an inference model by performing learning in accordance with a control signal indicating the texture of each region of the image for learning, using a trainee image and a training image, the trainee image being generated by performing predetermined image processing on the image for learning, the training image being the image for learning.

### REFERENCE SIGNS LIST

1 Learning device
2 Image processing device
11 Texture label definition unit
12 Texture label assignment processing unit
13 Degradation processing unit
14 DNN learning unit
15 Texture axis value conversion unit
16 Object detection unit
17 DNN learning unit
31 Object detection unit
32 Inference unit
33 Texture axis value conversion unit
34 Image quality adjustment unit
35 Inference unit

1. An image processing device comprising:
a control signal generation unit that generates a control signal indicating a texture of each region formed in an output image as an inference result, on a basis of an input image to be processed; and
an image generation unit that inputs the input image to an inference model, and infers the output image in which each region has a texture indicated by the control signal, the inference model being obtained by performing learning based on a trainee image and a training image, the trainee image being generated by performing predetermined image processing on the training image, the texture of each region being expressed by a texture label in the training image.

2. The image processing device according to claim 1, further comprising
a texture detection unit that inputs the input image to another inference model, and infers the texture label expressing the texture of each region formed in the output image, the another inference model being obtained by performing learning with trainee data and training data, the trainee data being an image generated by performing the predetermined image processing on an image for learning, the training data being a texture label expressing a texture of each region of the image for learning, wherein
the control signal generation unit generates the control signal on a basis of the texture label that is an inference result.

3. The image processing device according to claim 2, wherein
a plurality of types of texture labels expressing qualitative textures and texture intensities is defined.

4. The image processing device according to claim 3, further comprising
a conversion unit that converts a texture intensity expressed by the texture label inferred as the inference result with the another inference model into a numerical value, on a basis of a likelihood, wherein
the control signal generation unit generates the control signal indicating a type of the texture expressed by the texture label as the inference result, and the numerical value.

5. The image processing device according to claim 4, wherein
the control signal generation unit adjusts a relationship between the texture intensity and the numerical value, in accordance with an object included in each region.

6. The image processing device according to claim 1, wherein
the control signal generation unit generates the control signal corresponding to a texture of each region, the texture being designated by a user.

7. The image processing device according to claim 1, further comprising
an object detection unit that detects an object included in the input image, wherein
the learning of the inference model is performed by learning a coefficient that varies with each object included in the training image, and
the image generation unit inputs the input image to the inference model in which a coefficient corresponding to an object included in the input image is set, and infers the output image.

8. The image processing device according to claim 1, wherein
the texture of each region is expressed with a texture of an object included in each region.

9. An image processing method implemented by an image processing device, the image processing method comprising:
generating a control signal indicating a texture of each region formed in an output image as an inference result, on a basis of an input image to be processed; and
inputting the input image to an inference model, and inferring the output image in which each region has a texture indicated by the control signal, the inference model being obtained by performing learning based on a trainee image and a training image, the trainee image being generated by performing predetermined image processing on the training image, the texture of each region being expressed by a texture label in the training image.

10. A program for causing a computer to perform a process of:
generating a control signal indicating a texture of each region formed in an output image as an inference result, on a basis of an input image to be processed; and
inputting the input image to an inference model, and inferring the output image in which each region has a texture indicated by the control signal, the inference model being obtained by performing learning based on a trainee image and a training image, the trainee image being generated by performing predetermined image processing on the training image, the texture of each region being expressed by a texture label in the training image.

11. A learning device comprising:
an acquisition unit that acquires a texture label indicating a texture of each region of an image for learning; and
a learning unit that generates an inference model by performing learning in accordance with a control signal indicating the texture of each region of the image for learning, using a trainee image and a training image, the trainee image being generated by performing predetermined image processing on the image for learning, the training image being the image for learning.

12. The learning device according to claim 11, further comprising
another learning unit that performs learning using trainee data and training data, and generates another inference model, the trainee data being an image generated by performing the predetermined image processing on the image for learning, the training data being the texture label indicating the texture of each region of the image for learning.

13. The learning device according to claim 12, wherein
a plurality of types of texture labels expressing qualitative textures and texture intensities is defined.

14. The learning device according to claim 13, further comprising
a conversion unit that converts a texture intensity indicated by the texture label indicating the texture of each region of the image for learning into a numerical value, wherein
the learning unit learns the inference model in accordance with the control signal indicating a type of the texture indicated by the texture label indicating the texture of each region of the image for learning, and the numerical value.

15. The learning device according to claim 11, further comprising
an object detection unit that detects an object included in the image for learning, wherein
the learning unit learns the inference model by calculating a coefficient that varies with each object included in the image for learning.

16. The learning device according to claim 11, further comprising
an image processing unit that performs a degradation process as the predetermined image processing on the image for learning.

17. The learning device according to claim 11, wherein
the acquisition unit acquires a texture label indicating a texture of each region of the image for learning, the texture label being set in accordance with an operation performed by a user.

18. A generation method implemented by a learning device, the generation method comprising:
acquiring a texture label indicating a texture of each region of an image for learning; and
generating an inference model by performing learning in accordance with a control signal indicating the texture of each region of the image for learning, using a trainee image and a training image, the trainee image being generated by performing predetermined image processing on the image for learning, the training image being the image for learning.

19. A program for causing a computer to perform a process of:
acquiring a texture label indicating a texture of each region of an image for learning; and
generating an inference model by performing learning in accordance with a control signal indicating the texture of each region of the image for learning, using a trainee image and a training image, the trainee image being generated by performing predetermined image processing on the image for learning, the training image being the image for learning.
